(19) United States
(12) Patent Application Publication
(10) Pub. No.: US 2014/0009309 A1
(43) Pub. Date: Jan. 9, 2014

(54) Method And System For Streaming Data For Consumption By A User

(71) Applicants: Carmen DiCamillo, Philadelphia, PA (US); Mary Farrell, Philadelphia, PA (US); John Sullivan, Pleasant Mount, PA (US)

(72) Inventors: Carmen DiCamillo, Philadelphia, PA (US); Mary Farrell, Philadelphia, PA (US); John Sullivan, Pleasant Mount, PA (US)

(73) Assignee: INFORMATION LOGISTICS, INC., Pennsauken, NJ (US)

(21) Appl. No.: 14/006,549

(22) PCT Filed: Apr. 18, 2012
(86) PCT No.: PCT/US12/34035

§ 371 Date: Sep. 20, 2013

Related U.S. Application Data
(60) Provisional application No. 61/517,322, filed on Apr. 18, 2011.

(51) Int. Cl. H04L 29/06; G08G 1/0967

(52) U.S. Cl. CPC H04L 65/601; G08G 1/0967
USPC 340/905; 709/219

(57) ABSTRACT

A computer system and method of streaming streamable data to a device of a user, the method including determining a next quantum of streamable data from data available from a user queue of streamable data of a current channel based on user information; and streaming the next quantum of streamable data from the user queue to the device of the user. A computer system and method of providing eyes-free highway advisories to a driver, the method including in response to receiving a geographic location of the driver from an application on a wireless device of the driver, streaming current roadway conditions to the wireless device; and monitoring the location of the driver and streaming highway advisories to the wireless device if the driver is within a range of the highway advisory.

### CROSS-REFERENCE TO RELATED PATENT APPLICATION

This application claims the benefit of U.S. Provisional Patent Application No. 61/517,322 filed on Apr. 18, 2011, the entire disclosure of which is incorporated herein by reference.

### FIELD

The present disclosure relates to streaming data, and more particularly to streaming data where a system determines the next quantum of streaming data to stream to a user device based on generating a customized queue for the user.

### BACKGROUND

In the discussion of the background that follows, reference is made to certain structures and/or methods. However, such references should not be construed as an admission that those structures and/or methods constitute prior art. Applicant expressly reserves the right to demonstrate that such structures and/or methods do not qualify as prior art.

Many people are overwhelmed with information. There is far too much information for the average person to consume. Much of the information is in a streamable data form such as audio, video, or text that can be converted to audio. There are very few ways of organizing the information and presenting the information to the user in a format that is convenient for the user to consume the information. Moreover, many people drive while their attention is distracted by information displays in their automobiles.

### SUMMARY

Therefore, there is a need in the art for a computer system and method of streaming streamable data to a device of a user. The method of streaming streamable data to a device of a user including determining a next quantum of streamable data from data available from a user queue of streamable data of a current channel based on user information; and streaming the next quantum of streamable data from the user queue to the device of the user.

The streamable data may be audio data, video data, and static images.

The user information may be a geographic location of the user, preferences of the user, or a time of day.

The method of streaming streamable data to a device of a user may include streaming an audio tone indicating a category of the next quantum of streamable data to the device of the user.

The method of streaming streamable data to a device of a user may include receiving new streamable data, in response to said new streamable data determining a position for the new streamable data in the user queue based on a user information, system rules, access information of the user queue, and operating parameters of the user queue.

The method of streaming streamable data may include in response to an input from the user during the streaming the next quantum of streamable data, determining another user associated with the next quantum streamable data, receiving from the device of the user a second streamable data, and streaming the second streamable data to the another user as a private message from the user to the another user.

A computer system and method of providing eyes-free highway advisories to a driver is provided. The method including in response to receiving a geographic location of the driver from an application on a wireless device of the driver, streaming current roadway conditions to the wireless device; and monitoring the location of the driver and streaming highway advisories to the wireless device if the driver is within a range of the highway advisory.

The wireless device may be a smart phone.

The wireless device may be a tablet computer.

The method may be both hands-free and eyes-free after initiating the method.

A computer system for streaming streamable data to a device of a user is provided. The computer system includes a processor adapted to: determine a next quantum of streamable data of a user queue of streamable data of a current channel based on user information; and stream the next quantum of streamable data from the user queue to the device of the user.

It is to be understood that both the foregoing general description and the following detailed description are exemplary and explanatory and are intended to provide further explanation of the invention as claimed.

### BRIEF DESCRIPTION OF THE DRAWING

The following detailed description can be read in connection with the accompanying drawings in which like numerals designate like elements and in which:

FIG. 1 schematically illustrates an example of a system for streaming streamable data for consumption by a user.

FIG. 2 schematically illustrates an example of the system for streaming streamable data for consumption by a user illustrated in FIG. 1.

FIG. 3 schematically illustrates an example of the system for streaming streamable data for consumption by a user illustrated in FIG. 1.

FIG. 4 schematically illustrates an example of a user queue.

### DETAILED DESCRIPTION

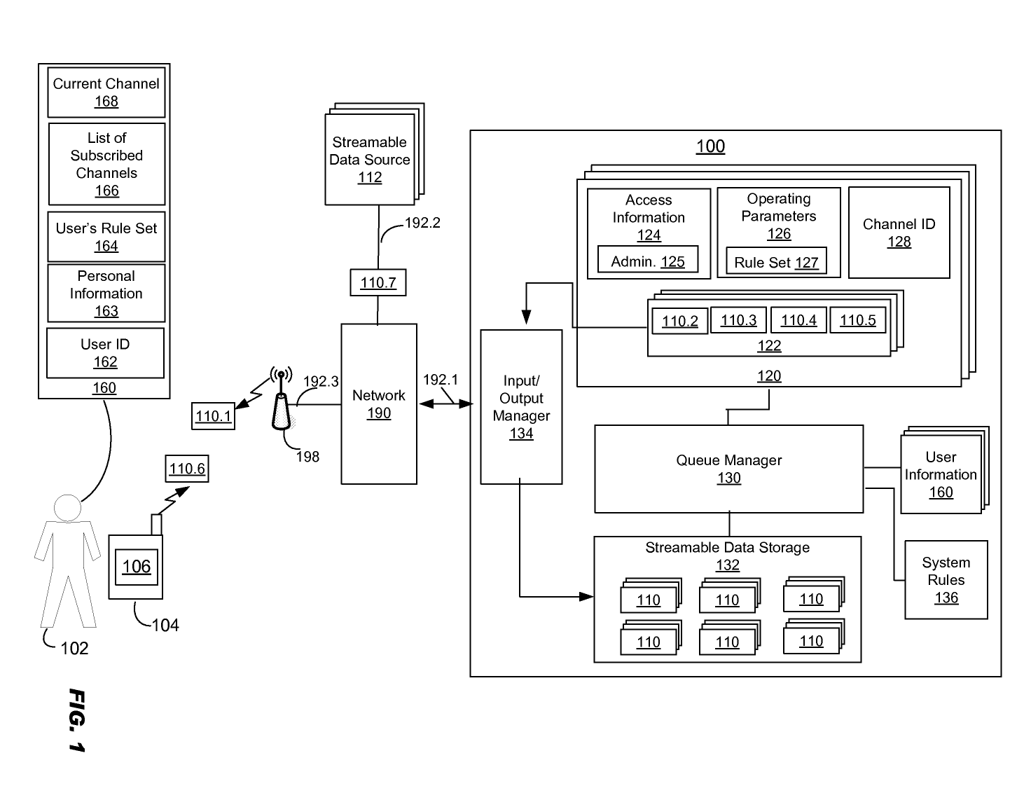

FIG. 1 schematically illustrates an example of a system 100 for streaming streamable data 110 for consumption by a user 102. The system 100 includes streamable data storage 132, channels 120, queue manager 130, user information 160, input/output manager 134, and system rules 136. Also illustrated in FIG. 1 is a user 102, a user device 104, network 190, network connections 192, cellular telephone tower 198, and streamable data sources 112. The queue manager 130 determines a quantum of streamable data 110 to stream to the user 104 from the user queue 122, and sends the determined streamable data to the input/output manager 134, which streams the streamable data 110 to the user device 104 for consumption by the user 102. As illustrated in FIG. 1, a quantum 110.1 streamable data 110 is being streamed to the user device 104 from the system 100.

The user 102 is a person. The user device 104 is an electronic device that is capable of receiving streamable data 110. Examples of the user device 104 include a cellular telephone, a computer, dedicated voice over Internet protocol (VOIP) phone, and a tablet computer. The user device 104 may include a global position system (GPS) to determine the geographic location of the user device 104.

The user device 104 may include an application 106 that interacts with the system 100. For example, the application 106 may be an application on an iPhone™ or other “smart phone” or smart electronic device.

The streamable data 110 is a discrete quantum of streamable data 110. Some examples of streamable data 110 are a message that there is accident ahead on the highway, a message from another user 102 that there is a police car ahead on the highway, a message from a friend recorded on a channel 120 for communicating with friends, and music. Information may be associated with the streamable data 110, for example, a user ID 162 of the user that either originated the streamable data 110 or for whom the streamable data 110 is intended. A channel 120 may be associated with the streamable data 110. A recording method may be associated with the streamable data 110. For example, a recording method may be that the streamable data 110 was recorded by a user 102 speaking into a user device 104. A date and time may be associated with the streamable data 110 indicating when the streamable data was stored on the system or when the streamable data 110 was recorded. A compression-decompression (codec) may be associated with the streamable data 110 that indicates how streamable data 110 was compressed and may indicate how to decompress the streamable data 110 by the system 100 or the user device 104. A duration, geographic location, and/or size may be associated with the streamable data 110.

Streamable data storage 132 may be a database of streamable data 110. The streamable data 110 may have information associated with it stored in the streamable data storage 132.

The channel 120 includes user queues 122, access information 124, operating parameters 126, and channel ID 128. A channel 120 may be shared by more than one user 102 and each individual user 102 of the channel 120 may have their own user queue 122 that is a queue of streamable information 110 for the individual user 102. The system 100 may have many active channels 120. Each user 102 may be tuned to a different channel 120 so that there may be as many channels 120 active as there are users 102 tuned to channels 120. When more than one user 102 tunes to the same channel 120, then a separate user queue 122 is created for each user 102.

The user queues 122 may be specific to a particular individual user 102, or the user queue 122 may be shared by more than one user 102. A user queue 122 includes streamable data 110 that is queued for being streamed to a user device 104 for consumption by a user 102. Streamable data 110 may be added, rearranged, or deleted from the user queue 122.

Access information 134 includes administrator 125. Access information 134 may include information that determines which users 102 may access the channel 120. Some examples of access information 134 are geographic location of user, age of user, list of users either permitted access or denied access, and an indication that the channel is a public channel open to all users 102. Other information may be used to determine which users 102 can access a channel 120.

The administrator 125 may be information that indicates which users 102 may administer the channel 102. The administrator 125 may change access information 124, operating parameters 126, and channel ID 128.

The operating parameters 126 include rule set 127. The operating parameters may include operating parameters 126 for the channel 120. For example an operating parameter 126 may be a maximum amount of streamable data 110 that a user 102 can add to the user queue 122. The operating parameters 126 may include a unique streaming universal resource locator (URL) address for that can be used to access the channel 120.

Rule set 127 may includes rules that affect the operation of the channel 120. An exemplary rule set 127 may have rules that assign some users 102 as students and some users 102 as teachers. Streamable data 110 received from a teacher may go to the head of the user queues 122 whereas streamable data 110 received from a student may go to the end of the user queues 122.

The user information 160 is illustrated both above the user 102 and within the system 100 for convenience so that it is clear that the user information 160 is associated with user 102, but also used by the system 100. The user information 160 may be stored within the system 100 or portions may be stored on the user device 104 or at other locations external to the system 100. The user information 160 may include a user ID 162, personal information 163, user's rule set 164, list of subscribed channels 166, and current channel 168.

The user ID 162 may be a user identification that may be used to identify the user to the system 100. The personal information 163 may include, for example, an age of the user, languages spoken with preferred language, and address.

The user's rule set 164 may be rules that the system 100 uses to determine how to stream streamable data 110 to the user device 104. The user's rule set 164 may indicate a channel 120 that a rule is applicable for. For example, a rule of the user's rule set 164 may be that streamable data 110 that is older than 10 minutes is deleted from the user's queue 122 for a channel 120 for chatting with other users 102. Another example of a user's rule set 164 may be to play streamable information 110 from a channel for highway alerts while the current channel 168 of the user 102 is a channel for playing songs.

The list of subscribed channels 166 may be a list of channels 120 that the user 102 has subscribed to. The current channel 168 may be the channel 120 that the user 102 is currently tuned to.

Streamable data originates at streamable data sources 112 that generate streamable data 112 that are sent to the system 100. An example of a streamable data source 112 is a department of transportation of a state that may send traffic alerts to the system 100 as streamable data 110. Other examples include news feeds, stock price feeds, etc. The network 190 may be a network such as the Internet, or local or wide area network.

The connections 192 are connections from the network 190 to electronic devices. For example, connection 192.1 is a connection from the system 100 to the network 190. Connection 192.1 may be router that is connected to the Internet.

Cellular tower 198 may be a cellular tower for sending and receiving information to and from a user device 104.

Input/output manager 134 handles the input and output from the system 100. The input/output manager 134 may include functionality for converting information data from one data format to another data format, and may include functionality to compress or decompress streamable data 110. The input/output manager 134 is configured to stream the streamable data 110 to the user device 104. In embodiments, the input/output manager 134 is configured to determine a type of input/output handling for the user device 104. For example, the input/output manager 134 may poll the user device 104 regularly or intermittently to determine the geographic location of the user device 134. How often the input/output manager 134 polls the user device may be based at least on one or more of the channel 120 the user 102 is tuned to, how fast the user device 104 is moving, and the cost of polling the user device 104 in terms of charges that the user device 104 may incur from a network provider.

The queue manager 130 may manage the user queues 122 of the channels 120. The queue manager 130 examines streamable data 110 in the user queues 122, the streamable data storage 132, and data received from outside the system 100 through the input/output manager 134 to determine the next quantum of streamable data 110 to stream to a user device 104, how and whether to reorder the user queues 122, and whether to add or remove streamable data 110 to user queues 122. The queue manager 130 may make these determinations based at least on the user information 160, system rules 136, access information 124, and operating parameters 126. The system rules 136 may be rules that are used to determine how the streamable data 110 is stored and streamed in the system 100. In embodiments, the queue manager 130 may update each time new streamable data 110 is received by system 100. In embodiments, the queue manager modifies the user queues 122 on a periodic basis to ensure that streaming data is placed in the user queues 122 for periodic commercials and channel identification. In embodiments, the queue manager 130 purges streamable data 110 on a regular basis to remove streamable data 110 already streamed to the user 102 and, in some channels 120, streamable data 110 that is old, i.e., past a time set in the operating parameters 126 or in the system rules 136, is purged. In embodiments, the queue manager 130 determines that in highly active channels 120 some streamable data 110 may be purged because it will likely never be heard due to the large amount of streamable data 110 in the user queues 122.

In operation the queue manager 130 determines the next quantum of streamable data 110 to be streamed for each of the user queues 122. The input/output manager 134 streams the next quantum of streamable data 110 for each of the users 102 associated with the corresponding user queues 122. The input/output manager 134 receives streamable data 110.7 from streamable data source 112. The input/output manager 134 may convert the data into an appropriate format for storage on the system 100. The input/output manager 134 may then put the streamable data 110 in the streamable data storage 132 where the queue manager 130 may examine the streamable data 110 to determine whether or not to place the streamable data 110 on a user queue 122 or select the new streamable data 110 as the next quantum of streamable data 100 to stream to the use device 104.

An example of the system 100 will now to described. Channel 120 may be for a highway alert channel for users 102 that are driving. The user 102 launches an application 106 for tuning to channel 120 on their user device 104, which may be an iPhone™ or other device. The application 106 connects to the system 100 via an Internet address. The system 100 may identify the user 102 based on information the application 106 sends to system 100. The system 100 then tunes the application 106 to channel 120 based on information the application 106 provides to the system 100. The system 100 may tune the application 106 to channel 120 based on the Internet address the application 106 addressed.

The system 100 creates a user queue 122 for the user 102 for channel 120. The user queue 122 may have been previously created when the user 102 previously tuned to channel 120 and the user queue 122 may have been stored in the system 100 for later use by the user 102. The user queue 122 illustrated on top of the user queues 122 is the active user queue 122 for the user 102.

The queue manager 130 determines the next quantum of streamable data 110 to stream to the user device 104 when the user 102 tunes the channel 120. The queue manager 130 determines that the channel ID 128 should be the next quantum of streamable data 110 to be streamed. The queue manager 130 indicates to the input/output manager 134 that the Channel ID 128 is to be streamed to the user device 104. The input/output manager 134 then streams the Channel ID 128 to the user device 104. For example, the input/output manager 134 may send the streamable data 110 that is voice data of the channel ID 138 such as “Welcome to the Highway Alert Channel of Open Microphone (trademark).” The input/output manager 134 may stream the streamable data 110 by sending via a router (network connections 192.1), then over the Internet (network 190), and then to a gateway from Internet protocol to a cellular tower 198. The user device 104 receives the streamable data 110 of the Channel ID 128. The application 106 may then cause the device 104 to play the voice data of the Channel ID 128.

The user device 104 uses a global positioning system (not illustrated) to determine a geographic location of the user 102 who is driving in a car (not illustrated.) The application 106 converts the geographic location into streamable data 110.6 and instructs the user device 104 to send the streamable data 110.6 to the system 100. The streamable data 110.6 is received by the cellular tower 198, is sent via the network connection 192.1, and sent via the network 190, and finally sent via network connection 192.1 to the input/output manager 134. The input/output manager 134 stores the streamable data 110.6 in the streamable data storage 132. In embodiments, the input/output manager 134 may store the streamable data in a cache for faster access to the streamable data 110 for the queue manager 130. In embodiments, the input/output manager 134 indicates to the queue manager 130 that streamable data 110.6 was received that should be considered. The streamable data 110.6 has associated with it an User ID 162 that the queue manager 130 uses to update the user information 160 associated with the user 102 regarding the location of the user 102. The streamable data sources 112 send an alert that there is an accident on a highway that user 102 is traveling on. The streamable data sources 112 are created by the department of transportation in the state that the user 102 is driving. The alert is sent as streamable data 110.7 via network connection 192.2, Network 190, and network connection 192.1 to the input/output manager 134. The input/output manager 134 stores the alert as streamable data 110.7 in the streamable data storage 132.

The queue manager 130 once again determines the next quantum of streamable data 110 to stream to the user device 104. The queue manager 130 uses a database of highways and locations (not illustrated) to determine the highway the user 102 is traveling on. The user device 104 sends a second geographic location to the system 100 which enables the queue manager 130 to determine that the user 102 is traveling on the highway in the direction toward the location that prompted the alert. The queue manager 130 determines that the next quantum of streamable data 110 to the user 102 should be the alert, so the queue manager 130 indicates to the input/output manager 134 to stream streamable data 110.7 to user device 104. The user 102 of the user device 104 may then take an alternative route to avoid the alert.

The streamable data 110.7 may have been received as text from the streamable data sources 112, which was the department of transportation. The input/output manager 134 may invoke a text to voice converter after receiving the text alert as streamable data 110.7. The input/output manager 134 may then store the voice version of the alert in the streamable data storage. The input/output manager 134 may use natural language processing software to determine the location of the alert such as the highway and convert this into a digital form so that the queue manager 130 can compare the location of the user 102 with the location of the alert to determine whether or not to stream the alert to the user 102.

The user's rule set 164 may include a rule that when the user 102 is traveling on highways that only highway alerts that are applicable to the highway the user is traveling on should be streamed to the user 102. In this way, the user 102 will not receive highway alerts that may be geographically close to the where the user 102 is driving but only apply to a side road that would not affect the highway the user 102 is driving on.

The queue manager 130 may determine the highway the user 102 is traveling on by sending the geographical information to another system and then receiving highway information back from the other system.

In this example, the access information 124 may have indicated that all users are permitted access to the channel 120. The administrator 125 of the highway alert channel 120 may be an employee of the company that provides the system 100, or the administrator 125 may be a user 102. The queue manager 130 may periodically stream an advertisement to the user 102, and the advertisement may be geographically sensitive and may be targeted to the user 102 based on the user information 160 and/or based on other information the system 100 may have gathered regarding the user 120. The operating parameters 126 may include rules such as that streamable data 110 that is more than several hours old should not be streamed to the user 102 as it is unlikely to still be applicable. The user rule set 164 may include a rule that the user 102 only wants “serious” alerts, e.g. highway closure or traffic diversions, streamed to the user device 104.

The user 102 may be driving a truck. The user 102 may use application 106 to join the highway alert channel 120 and associate a truck highway alert channel (not illustrated) with the highway alert channel 120. By associating the truck highway alert channel with the highway alert channel 120 streamable data on the user queue (not illustrated) of the truck highway alert channel (not illustrated) is put in the user queue 122 of the highway alert channel 120. The list of subscribed channels 166 may include an entry that the user 102 is tuned to highway alert channel 120 and associated with the truck highway alert channel. The user 102 may then have a user queue 122 for both the highway alert channel and the truck highway alert channel. The queue manager 130 would then examine both user queues 122 when determining the next quantum of streamable data 110 to stream. This is a convenient way for a user 102 driving a truck to get highway alerts intended for all drivers and highway alerts that are intended only for truck drivers. Alternatively, or in addition, the user 102 may indicate in the personal information 163 that the user 102 is driving a truck, and the queue manager 130 may put streamable data 110 on the user's queue 122 that is applicable to truck drivers.

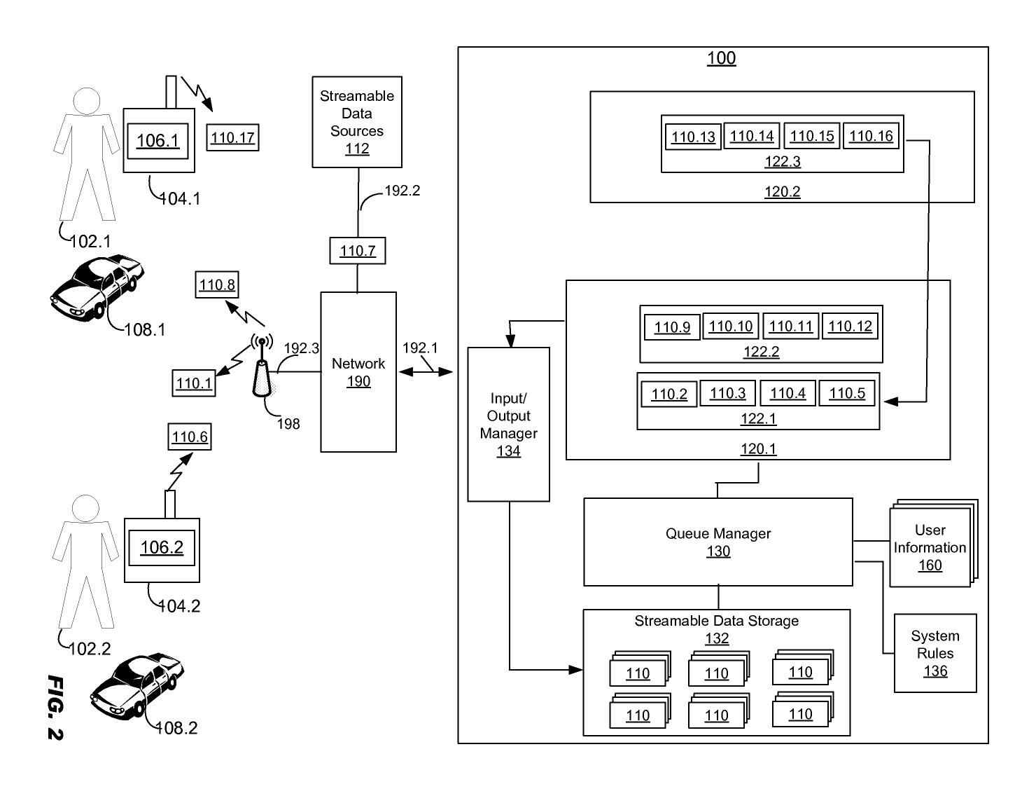

FIG. 2 schematically illustrates an example of the system 100 for streaming streamable data for consumption by a user illustrated in FIG. 1. The system 100 includes streamable data storage 132, channel 120.1, channel 120.2, queue manager 130, user information 160, input/output manager 134, and system rules 136. Also illustrated in FIG. 2 is user 102.1, user device 104.1, user automobile 108.1, user 102.2, user device 104.2, user automobile 108.2, network 190, network connections 192, cellular telephone tower 198, and streamable data sources 112.

As illustrated in FIG. 2, both user 102.1 and user 102.2 are tuned to channel 120.1. User queue 122.1 is user 102.1's user queue. User queue 122.2 is user 102.2's user queue. Channel 120.1 in FIG. 2 is a discussion channel for drivers to, for example, discuss police activity on the highway. User 102.1 has channel 120.2 associated with channel 120.1 in user 102.1 list of subscribed channels 166 (see FIG. 1). Because of the association between channel 120.1 and 120.2 for user 102.1, the queue manager 130 may stream streamable data 110 from both the user queue 122.1 and the user queue 122.3 to user 102.1. Channel 120.2 in this example is the highway alert channel as discussed in FIG. 1.

In operation, user 102.1 and 102.2 tune to channel 120.1 by launching the application 106.1 and 106.2 respectively on their user devices 104. When user 102.1 and user 102.2 speak into their user devices 104, then their speech may be turned into streamable data 110.17 and 110.6 respectively, and sent to the system 100. The input/output manager 134 receives and stores the streamable data 110.6 and 110.17 in the streamable data storage 132. The queue manager 130 determines whether or not to place the streamable data 110.6 of user 102.2 on user queue 122.1 for streaming to user 102.1. The queue manager 130 may make this determination based on one or more of the user information 160, the system rules 136, access information 124, and operating parameters 126. The queue manager 130 may determine whether or not to place the streamable data 110.6 on user queue 122.1 based on whether or not user 102.1 and user 102.2 are geographically close to each other and traveling on the same highway. The queue manager 130 may also make this determination based on the user information of user 102.1 and user 102.2. For example, the user information of user 102.1 may include that automobile 102.1 is a truck and user's rule set 164 (FIG. 1) may include a rule to only include streamable data 110 from other truckers.

When determining the next quantum of streamable data 110 to stream to user 102.1, the queue manager 130 examines streamable data 110 in both user queue 122.1 and 122.3 since user 102.1 has an association between channel 120.1 and 102.2 in user 102.1's list of subscribed channels 166 (FIG. 1). The queue manager 130 may make this determination based on one or more of the user information 160, the system rules 136, access information 124 of both channels 120.1 and 120.2, and operating parameters 126 of both channels 120.1 and 102.2. For example, if streamable data 110.13 is a highway alert that is geographically very close to user 102.1 and indicates a serious problem, the rule set 127 of channel 120.2 may include a rule that if the highway alert is geographically very close to a geographical location of user 102, and the highway alert indicates a serious problem, that the highway alert 110.13 should be placed at the front of the user queue 122 of any associated channels 120. Based on this rule, the queue manager 130 may determine that the next quantum of streamable data 110 to stream to user 102.1 is highway alert 110.13. Streamable data 110 that originated from user 102.2 may still be streamed to user 102.1, but may be delayed until the highway alert 110.13 is streamed to user 102.1. User 102.1 could have a rule in that user's rule set 164 (FIG. 1) that, if streamable data 110 is delay due to a highway alert for more than 30 seconds the streamable data 110 should be deleted from the user queue 122.

In embodiments, the application 106 and/or the system 100 may be context sensitive so that when streamable data 110 from a user 102.1 is being streamed to another user 102.2, the user 102.2 can indicate that the user 102.2 would like to respond to user 102.1 privately. For example, in the example of the police discussion channel 120.1, there may be hundreds or thousands of users tuned to the channel 120.1. User 102.1 may send out a message on channel 120.1 regarding a restaurant and user 102.2 may indicate that they want to respond privately to user 102.1 by selecting a control on user device 104.2. For example, user 102.2 may press the “1” key on a telephone keypad. The system 100 may stream a prompt such as speak private message, which may be stored locally so that the application 106.2 can access the message without accessing the network 190. The user 102.2 may then speak a message that is then sent as a streamable data 110 to user 102.1 via user 102.1 user queue 122.1. User 102.1 may have a user's rule set 164 in the user information 160 of user 102.1 that prevents the streaming of private messages in response to streaming data 110 user 102.1 sends on channel 120. In this way, the user 102.2 may respond privately to user 102.1 in response to streamable data 110.1 received from user 102.1. In embodiments, user 102.1 may remain anonymous. In embodiments, based on the user information 160 user 102.1 may be prompted by the system 100 as to whether user 102.1 would like their identity revealed to user 102.2.

In embodiments, the system 100 may provide a GeoTalker (Trademark) channel 120, which may have an application for the user device 104. The queue manager 130 places on the user queue 122 all the roadway conditions and then streams the roadway conditions to the user device 104 when the application is first run. The queue manager 130 will then not select a next quantum of streamable data 110 until a highway advisory becomes within the range of the user 102, or until a new advisory is applicable to the user 102. The user 102 can set an advisory replay interval in the operating parameters 126 of the user channel 122. In embodiments, a GeoTalker application is run on a smart phone 104. The GeoTalker application uses, for example, a GPS of the smart phone 104 about every two minutes to obtain a geographic location of the user 102. By only sending the geographic location every couple of minutes the GeoTalker application saves power of the smart phone 104 and may save on network 190 resources. The GeoTalker provides the advantage that the user 102 is provided with a hands-free and eyes-free highway advisory smart phone 104. The user 102 could associate another channel 120 with the GeoTalker channel 120 such as a radio channel 120 so that the user 102 could listen to radio programming between highway advisories. In embodiments, the GeoTalker application may determine the geographic location by other means provided by the smart phone 104 such as triangulation based on nearest cellular towers. In embodiments, the geographic location of the smart phone 104 may be determined across a network and transmitted to the smart phone 104.

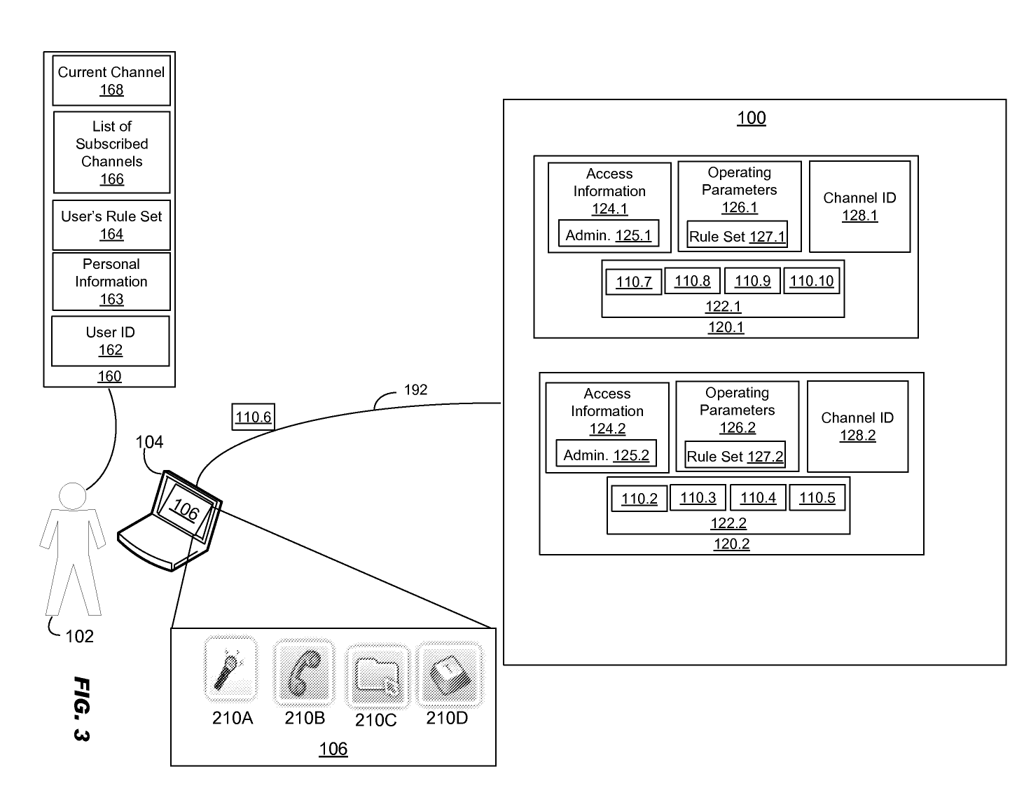

FIG. 3 schematically illustrates an example of the system 100 for streaming streamable data for consumption by a user illustrated in FIG. 1. Illustrated in FIG. 3 is user 102, user device 104, user information 160, network connection 192, and system 100 for streaming streamable data for consumption by a user 102. Some of the details of the system 100 are not illustrated in FIG. 3. User 102 may be tuned to channel 120.1 which is the user 102's personal information channel which the user 102 may record streamable data 110. The user 102 may speak into the user device 104 and record streamable data 110 to the system 100 that is stored in the user queue 122.1. For example, the user 102 may have recorded comments regarding attending a wedding of a friend, which is streamable information 110.7, a recent vacation to Florida, which is streamable data 110.8, and the recent graduation of their daughter from high school, which is streamable information 110.10. Streamable information 110.9 may be another user's 102 comments regarding the 102's recent trip to Florida, which is streamable data 110.8. When the user 102 records additional comments as streamable data 110, the new streamable data 110 may be added to the back of the user queue 122.1 by the system 100. The system 100 may provide the user the ability to preview, edit, delete, fast forward, slow play the streamable data 110 as well as provide additional functionality. The user 102 may be the administrator 125 of their own channel 120.1. The user 102 may set the access information 124.1 via an application 106 on the user device 104. The user 102 may set the some or all of the operating parameters 126.1 and the channel ID 128.1. An example channel ID 128.1 may be the name of the user 102 provided in personal information 153. The channel 120.1 may be associated with other channels 120 so that a user 102 could record or listen to the channel 120.1 and one or more associated channels 120 simultaneously.

The user 102 may tune to a channel 102.2 of another user 102. The user 102 can then listen to the streamable data 110 that is on the channel of another user 102, which may be from the another user 102, or may be from still other users 102 who have left messages on the user queue 122.2 of the other user 102.

The application 106 may provide a series of icons 210 for streamable data 110 input. The microphone icon 210A enables recording of streamable data 110 such as audio by use of devices on the user device 104 such as a microphone or camera (neither illustrated). Selection of the microphone icon 210A may begin audio recording and the application 106 may save the streamable data 110 until the audio recording is completed and then send the audio data 110 to the system 100. In embodiments, the application 106 may stream the recorded streamable data 110 while the user 102 is inputting the streamable data 110. The application 106 may provide the user 102 while recording the streamable data 110 with the ability to pause, resume, fast forward, rewind, etc. via input controls (not illustrated) that may be voice or gesture activated. The user 102 may set parameters such as how long the streamable data 110 is and whether to wait for an explicit “send to system 100” command or send the streamable data 110 automatically to the system 100.

The application 106 may respond to a selection of the telephone icon 2108 by the user 102 by presenting a common telephone number and a unique session generated code number. In embodiments, the automatically generated code may expire after a configurable time limit when the user has not used the generated code. The user 102 can call the presented phone number and then will be voice prompted for the code number. Once entered, the recording process is started. The user 102 is able to pause, start, stop, play and re-record the record much like a voice mail system. The recorded streamable data 110 is then stored in streamable data storage 132 and may be placed in a user queue 122. In embodiments, the system 100 will call the user 102. In embodiments, after selecting the telephone icon 210B, the system 100, which may be the application 106, may prompt the user 102 for a telephone number for the system 100 to call to enable the user 102 to record streamable data 110. In embodiments, selection of the telephone icon 210B, will cause the system 100 to call a dedicated DID (direct inward dialing) phone number to enable the user 102 to record streamable data 110. The user device 104 may have a unique identification associated with it that would enable the system 100 to call the user without the use of a generated code. For example, cellular telephone number may be used to uniquely identify a cellular telephone as a user device 104. The user 102 may then simply dial the telephone number provided by the system 100 and the system 100 would determine the cellular telephone number of the user device 104 and match this cellular telephone number to personal information 163 of the user 102 to verify the identify of the user 102. In embodiments, the user 102 may connect to the system using a voice over internet protocol (VOIP) conference phone with a system 100 provided session initiated protocol (SIP) address.

Selection of the folder icon 210C enables pre-recorded streamable data 110 such as audio or video files that are stored on the user device 104 to be uploaded to the system 100. A file tool link may be provided by application 106 for selection of a file on the user device 106. In embodiments, the size, duration and/or type of file are identified by the input/output manager 134 (FIGS. 1 and 2), and the administrator 125 may set operating parameters 126 that may limit the size, duration, or type of streamable data 110 that can be added to the user queue 122.

Selection of the keyboard icon 210D provides a text to speech tool where an area on the screen of the user device 104 is provided for the user 102 to type a message that is converted into an audio streamable data 110. After the user 110 enters the desired message, several voice types may be made available for selection. After making the voice sound selection, the user 102 may click an icon (not illustrated) that converts the text to speech and then transfers the streamable data 110 to the system 100, which may place the streamable data 110 on the user queue 122 and/or in the streamable data storage 132.

In embodiments, when the system 100 receives streamable data 110 the system 100 stores the streamable data in the streamable data storage 132. As discussed previously other data may be stored with the streamable data 110 such as user information 160, user channel 122, recording method used, date and time, codec used in the recording process, duration, size, and GPS location of user 102 when recorded.

Thus by allowing users 102 to record streamable data 110 and allow others to comment on the streamable data 110 by recording their own streamable data 110, the system 100 provides a convenient means for users 102 to broadcast their views and news to other users 102, and be streamed the views and news of other users 102.

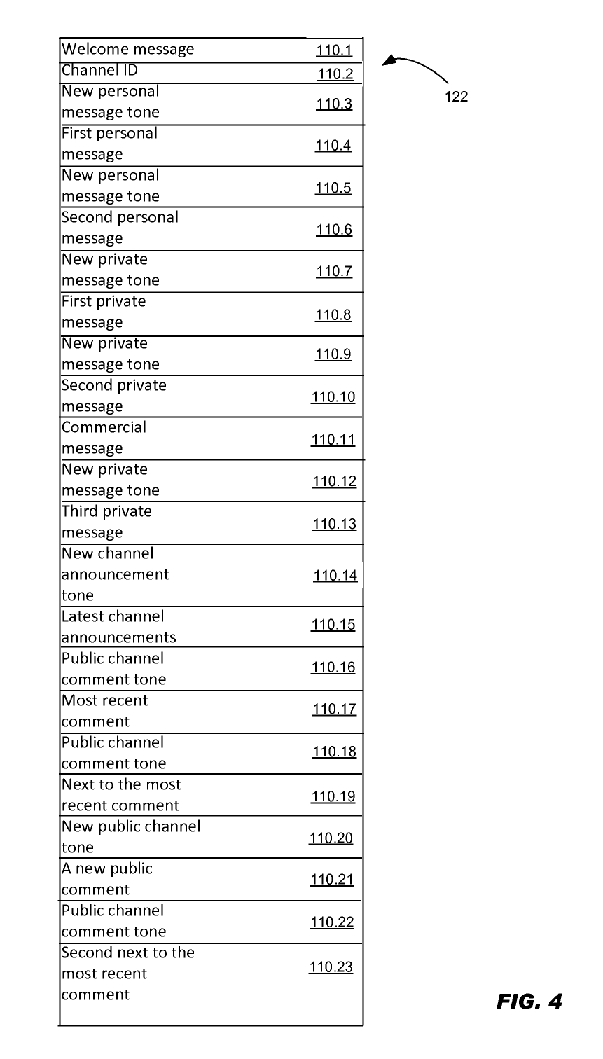

FIG. 4 schematically illustrates an example of a user queue 122. The first streamable data 110.1 is a welcome message that may be a message that identifies the system 100. The second streamable data 110.2 is a channel ID 128, which may be the name of the channel 120. The third streamable data 110.3 is a new personal message tone, which is an indication that a new personal message will be the next quantum of streamable data 110 streamed to the user 102. The fourth streamable data 110.4 is a first personal message 110.4, which may be a first personal message 110.4 that was determined by the queue manager 130 to be applicable to the user 102. The queue manager 130 made this determination based on the personal information 160 of the user 102, the system rules 136, the access information 124, and the operating parameters 126 of the channels 120 in the list of subscribed channels 166 of the user 102.

The fifth streamable data 110.5 is a new personal message tone, which is an indication that a new personal message will be the next quantum of streamable data 110 streamed to the user 102. The sixth streamable data 110.6 is a second personal message 110.6, which may be a second personal message 110.6 that was determined by the queue manager 130 to be applicable to the user 102. The seventh streamable data 110.7 is a new private message tone 110.7, which indicates the next quantum of streamable data 110.8 will be a private message. The eight streamable data 110.8 is a first private message 110.8, which may be a private message sent to the user 102 from another user 102 of the system. The ninth streamable data 110.9 is a new private message tone 110.9, which indicates the next quantum of streamable data 110.10 will be a private message. The tenth streamable data 110.10 is a second private message 110.10, which may be a private message sent to the user 102 from another user 102 (which may be a different user 102 than the user 102 of the eight streamable data 110.8) of the system.

The eleventh streamable data 110.11 may be a commercial message such as an advertisement to generate revenue for the system 100. The twelfth streamable data 110.12 is a new private message tone 110.12, which indicates the next quantum of streamable data 110.13 will be a private message. The thirteenth streamable data 110.13 is a third private message 110.13, which may be a private message sent to the user 102 from another user 102 (which may be a different user 102 than the user 102 of the eight streamable data 110.8 and a different user 102 than the user 102 of the tenth private message 110.10) of the system. The fourteenth streamable data 110.14 is a new channel announcement tone, which indicates that the next quantum of streamable data 110.15 will be channel announcements. The fifteenth streamable data 110.15 is latest channel announcements 110.15, which are announcement regarding the current channel 120.

The sixteenth streamable data 110.16 is a public channel comment tone 110.16, which indicates the next quantum of streamable data 110.17 will be a public comment. The seventeenth streamable data 110.17 is a most recent comment (public) 110.17. The eighteenth streamable data 110.18 is a public channel comment tone 110.18, which indicates the next quantum of streamable data 110.19 will be a public comment. The nineteenth streamable data 110.19 is the next to the most recent comment (public) 110.19. The twentieth streamable data 110.20 is a new public channel tone 110.18, which indicates the next quantum of streamable data 110.21 will be a public comment. The twenty-first streamable data 110.21 is a new public comment 110.21. The twenty-second streamable data 110.22 is a public channel tone 110.22, which indicates the next quantum of streamable data 110.22 will be a public comment. The twenty-third streamable data 110.23 is a second next to the most recent comment 110.23.

The queue 122 has the advantage of providing personalized streamable data 110 to a user 102 with tones to indicate the category of streamable data 110. In embodiments, the system 100 provides a user website (not illustrated) that provides a user 102 with the functionality to register with the system 100 and enter and modify user information 160 including current channel 168, list of subscribed channels 166, user's rule set 164, personal information 163, and user ID 162. In embodiments, the website provides a user 102 with the functionality to administer a channels 120 to modify access information 124, operating parameters 126, and/or Channel ID 128. To register with the system 100 a user 102 may be prompted for personal information 163 which may include an email address, which the system 100 may use to verify the user 102 registration. In embodiments, the system 100 may use other personal information 163 to verify the user registration. For example, the system 100 may use the cell phone number of the user 102, a user device 103 unique identification number (UID), or a digital signature. The system 100 may add to the list of subscribed channels 166 for the user 102 a personal streaming URL for computer or Internet Radio use channel 120, and a SIP URL for VOIP phone use channel 120. The system 100 may provide a channel 120 that can be accessed via telephone number and user id with a PIN number for use with a cellular telephone by the user 102. The system 100 may prompt the user for a cell phone number for the system 100 to call the user channel 120. Users can also enter their cell phone number to enable the Platform call-out feature.

In embodiments, a user 102 may use an Internet radio application (not illustrated) to listen to one of the channels 120 of system 100. By tuning the Internet radio to the unique streaming URL address provided in the operating parameters 126 of the channel 120, the system 100 will detect the connection and begin streaming the next quantum of streamable data 110 from the channel 120. The system 100 can detect when the connection to the Internet radio application is lost and will stop streaming the streamable data 110.

In embodiments, sales/want to buy channels 120 are provided. The sales/want to buy channels 120 have the advantage that a seller may give a detailed description of an item they wish to sell. A user 102 receiving the streamable data 110 from the seller may skip over the sales pitch or may follow up with a direct private response if the user 102 is interest. The user 102 may use the context response function to enter a streamable data 110 to the user 102 who is the seller of the item. Buyer channels 120 would provide a mechanism for a user that desires a specific item to make a request on the buyer channel 120, searching for a potential response from a user 102 seller.

In embodiments, compressed radio reception channels 120 are provided. The compressed radio reception channels 120 have the advantage that time compression can be used to remove the empty space from a stream of audio. For example, in air traffic or police radio transmissions, often most of the time is empty space. The system 100 can take air traffic or police radio transmission from a streamable data source 112 and associate the streamable data 110 to a channel 120 that a user 102 can then tune and have the streamable data 110 streamed to the user 102 without the empty space. For example, the operating parameters 126 could be set in the a police radio channel that would stream old streamable data 110 of police radio transmissions, and when a new police radio transmission was received from a streamable data source 112, the system 100 could determine that the streamable data 110 associated with the new police radio transmission would be the next quantum streamable data 110 to stream to the user 102 tuned to the police radio transmission channel 120. A tone could be streamed to the user 102 to indicate that the streamable data 110 was recently received by the system 100. The channel administrators 125 could permit users 102 to broadcast their own audio messages in response to the police radio transmissions, which would have the advantage of providing an enhanced “CB” type experience.

In embodiments, an archived greeting and messages channel 120 (“channel”) is provided. The channel 120 would have the advantage of permitting users 102 within a private group of user 102, which the administrator 127 could set in the access information 124, to leave and hear messages as streamable data 110 from one another. A user 102 could respond to a message as streamable data 110 either to the entire private group or to the individual that left the message. In embodiments, the system 100 provides for access to the system by a cellular telephone which would enable a user 102 with only a cellular telephone to hear and respond to a private group of achieved greetings and messages channel 120. In embodiments, the system 100 would respond to a command to call the user 102 associated with a streamable data 110 via one of the connection methods provided by the system 100 including cellular telephone. Additionally, messages as streamable data 110 could be designated to be stored permanently in the operating parameters 126, which would permit payback of the messages as streamable data 110 for years to come. The archived greeting and messages channel 120 provides a method by which grandparents may “speak” to future generations and can tie into other backup plans like finding family members in an emergency environment.

In embodiments, a newspaper channel 120 is provided. The channel 120 would provide a customized feed of news to the user 102. The user 102 could make rules in the user's rule set 164 applicable to the newspaper channel 120. The user's rule set 164 may include rules such as place on the user queue 122 news stories from streamable data sources 112 that include the name of a particular public company. The newspaper channel 120 provides the advantage of permitting the user 102 to have streamed streamable data 110 to the user 102 of only news that the user 102 is interested in consuming. The newspaper channel 120 could store news that satisfied the user's rule set 164 on the user queue 122 when the user was not tuned to the newspaper channel 120. The user 102 could tune to the newspaper channel 120 and have the news streamed to the user 102 at the convenience of the user 102.

In embodiments, the system 100 is free. Channels 120 can be created by individuals, organizations, schools and companies using the system 100. Revenue is generated in three ways. Advertisements may be sold. Click through display type advertisements are placed on the websites mentioned herein. Streamable data are inserted during the streaming of channels. Since each user 102 has user information 160 on the system 100, the system 100 can track every ad display, and every streamable data 110 advertisement streamed to the user 102, thereby providing analysis information to the advertisers, which may be sold to the advertisers.

Subscriber fees may be charged. Although the system 100 is free, certain user preferences associated with the user information 160 may be provided for a subscription fee. For example, the user information 160 may include an entry for whether the user 102 is paying a subscription fee, which may be for a particular channel 120 or the system 100, and then the operating parameters 126 of a channel (or alternatively the system rules 136) may include a rule that if a user 102 is paying subscription fees that some or all of the advertisements are not to be streamed to the user 102.

Storage and archiving fees may be charged. In embodiments, the free model will be based on “short term” storage of streamable data 110 such as audio and video records. Fees may be charged if users 102 or sponsors (which may be an administrator 125) desire a “long term” or “permanent” storage of their streamable data 110. This particularly applies to the “Archived Message” channel 120 as described above.

In embodiments, the system 100 will track the geographic location of a user 102. The user device 104 may have button (not illustrated), for example application 106 may have a graphical user interface button, that when pressed will activate tracking of the user 102. The tracking of the user 102 may continue until the user 102 turns off the tracking or until the use device 104 turns off. The advantage of tracking the user 102 is that if a user 102 is in need of help, the tracking may be used to locate the user 102. For example, the user 102 may have a medical condition where they may become unconscious, or the user 102 may be caught in a natural disaster such as a tornado. The user 102 may also press the button prior to an event such as a natural disaster or physical attack by a person to indicate that they believe they are in trouble and may need assistance and may not be able to reach help by themselves. The system 100 may prompt the user 102 after a period of remaining in the same geographic location to see whether or not the user 102 is ok. The system 100 may have a list of emergency contact to call if the user 102 does not respond to the prompt for whether or not the user 102 is ok.

In embodiments, the system 100 may be used to track a fleet of vehicles. The system 100 periodically receives the location of the user 102 and provides this information to a website application that a company can access to track a fleet of vehicles.

The invention has the advantage that by choosing the next quantum streaming data to stream to a user device that network bandwidth can be lessened because a user does not need to consume as much streamable data. The invention has the advantage of enabling a user to construct a customized stream of streamable data that is relevant to the information that the user wants to hear.

The device described herein may comprise a processor, a memory for storing program data and executing it, a permanent storage such as a disk drive, a communications port for handling communications with external devices, and user interface devices, including a touch panel, keys, buttons, etc. When software modules or algorithms are involved, these software modules may be stored as program instructions or computer readable codes executable on the processor on a computer-readable medium. The computer readable recording medium may be non-transitory. Examples of the computer readable recording medium include magnetic storage media (e.g., ROM, floppy disks, hard disks, etc.), and optical recording media (e.g., CD-ROMs, or DVDs). The computer readable recording medium can also be distributed over network coupled computer systems so that the computer readable code is stored and executed in a distributed fashion. This media can be read by the computer, stored in the memory, and executed by the processor.

The invention is described in terms of functional block components or and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the invention could employ any number of conventional techniques for electronics configuration, signal processing and/or control, data processing and the like. The word “configured” is used broadly and is not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device.

The use of the terms “a” and “an” and “the” and similar referents in the context of describing the invention (especially in the context of the following claims) are to be construed to cover both the singular and the plural. The steps of all methods described herein can be performed in any suitable order unless otherwise indicated herein or otherwise clearly contradicted by context. The invention is not limited to the described order of the steps. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in the art without departing from the spirit and scope of the invention.

What is claimed is:

1. A method of streaming streamable data to a device of a user, the method comprising:
determining a next quantum of streamable data from data available from a user queue of streamable data of a current channel based on user information; and
streaming the next quantum of streamable data from the user queue to the device of the user.

2. The method of streaming streamable data of claim 1, wherein the streamable data is at least one of audio data, video data, or static images.

3. The method of streaming streamable data of claim 1, wherein the streamable data is audio data.

4. The method of streaming streamable data of claim 1, wherein the user information is at least one of a geographic location of the user, preferences of the user, or a time of day.

5. The method of streaming streamable data of claim 1, further comprising:
streaming an audio tone indicating a category of the next quantum of streamable data to the device of the user.

6. The method of streaming streamable data of claim 1, further comprising:
receiving new streamable data,
in response to said new streamable data determining a position for the new streamable data in the user queue based on a user information, system rules, access information of the user queue, and operating parameters of the user queue.

7. The method of streaming streamable data of claim 1, further comprising:
in response to an input from the user during the streaming the next quantum of streamable data,
determining another user associated with the next quantum streamable data,
receiving from the device of the user a second streamable data, and
streaming the second streamable data to the another user as a private message from the user to the another user.

8. A method of providing eyes-free highway advisories to a driver, the method comprising:
in response to receiving a geographic location of the driver from an application on a wireless device of the driver,
streaming current roadway conditions to the wireless device; and
monitoring the location of the driver and streaming highway advisories to the wireless device if the driver is within a range of the highway advisory.

9. The method of providing eyes-free highway advisories to a driver of claim 8, wherein the wireless device is a smart phone.

10. The method of providing eyes-free highway advisories to a driver of claim 8, wherein the wireless device is a tablet computer.

11. The method of providing eyes-free highway advisories to a driver of claim 8, wherein the method is both hands-free and eyes-free after initiating the method.

12. A computer system for streaming streamable data to a device of a user, the system comprising:
a processor adapted to:
determine a next quantum of streamable data of a user queue of streamable data of a current channel based on user information; and
stream the next quantum of streamable data from the user queue to the device of the user.
